(19) United States
(12) Patent Application Publication
(10) Pub. No.: US 2003/0082293 A1
(43) Pub. Date: May 1, 2003

(54) Extract Bunkankasaponin A. B. C. D., crude fats, crude protein and sugar from the shell of Xanthoceras sorbifolia Bunge

(76) Inventors: Songjiang Wang, Thousand Oaks, CA (US); Baizhen Yang, Shenyang (CN); Chongfu Zhao, (US); Yu Guo, (US)

Correspondence Address: Songjiang Wang, P.O. Box 1692, Thousand Oaks, CA, 91358, US

(21) Appl. No.: 10/285,210

(22) Filed: Oct. 31, 2002

(30) Foreign Application Priority Data
Oct. 31, 2001 (CN) 01133388.X

(51) Int. Cl. A23L 1/28

(52) U.S. Cl. 426/655

(57) ABSTRACT

It is discovered that Bunkankasaponin A. B. C. D., crude fats, crude proteins and sugar can be extracted from the shell of Xanthoceras sorbifolia Bunge. The shell of X. sorbifolia used to be treated as waste material and not be utilized at all. This invention extracts 15˜25 percent of Bunkankasaponin A. B. C. D., 2˜10 percent of crude fats, 15˜30 percent of crude proteins, 20˜30 percent of sugar from the shell of X. sorbifolia. These extracts can be used making drugs to treat people with mental retardation and deficiency, etc., and has shown good effectiveness. The extracts can also be used as brain functional foods. The applications of these extracts from the shell of X. sorbifolia will convert the waste into useful materials and produce significant economic and social benefits.

### TECHNICAL FIELD

The invention relates to applications of Xanthoceras sorbifolia Bunge's shell.

### BACKGROUND OF INVENTION

Xanthoceras sorbifolia Bunge, also named as Xanthoceras sorbifolium, is a kind of woody oil-bearing plant of Xanthoceras Sapindaceae. It originated primarily at loess plateau in North of China, with characters of drought-enduring, cold-resistant, barren-enduring and saline-alkali-enduring. For these features, it has been planted in most provinces of northern China for windbreak and sand fixation.

X. sorbifolia's kernel contains about 60 percentage of fat that can be extracted to eatable oil. There is no any report, after researching both foreign and domestic documents, about extracting materials from the shell of X. sorbifolia so far. The shell of X. sorbifolia is still treated as waste material. There is no evidence of the Shell of X. sorbifolia being applied in medical and healthcare purposes.

### DISCLOSURE OF INVENTION

This invention has discovered that Bunkankasaponin A. B. C. D., crude fats, crude protein and sugar can be extracted from X. sorbifolia's shell. This shell is a thick phellem shell wrapping seeds up. It is also called skin of X. sorbifolia.

It has been verified by our study that the shell which Bunkankasaponin A. B. C. D., crude fats, crude protein and sugar can be extracted from is X. sorbifolia's shell.

Active materials in the X. sorbifolia's shell can be extracted through alcohol extraction. The extracts comprises 20˜30 percent of sugar, 2˜10 percent of crude fats, 15˜30 percent of crude protein, 15˜25 percent of Bunkankasaponin A. B. C. D. and 7˜12 percent of water. The structure of Bunkankasaponin A. B. C. D. extracted from the X. sorbifolia's shell is as the follows.

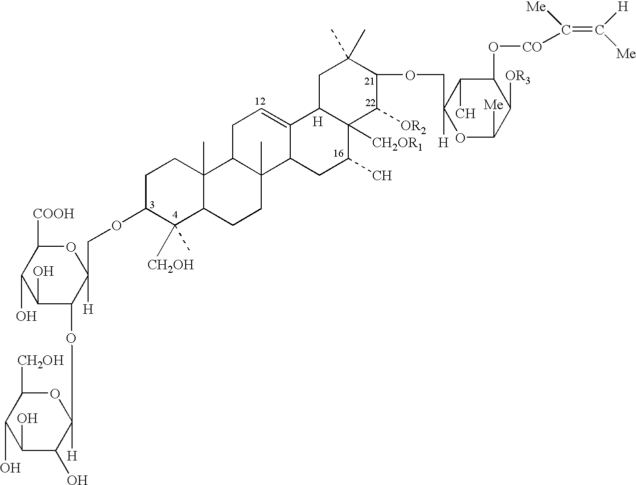

The extracts from the Shell of X. sorbifolia also include two kinds of sterols. They are (3β, 5α, 20R, 24S)-stigmasta-7, trans-22-dien-3-ol and (3β, 5α, 20R, 24R)-stigmasta-7-en-3-ol. However, these two sterols are not found in X. sorbifolia's kernel or any other parts of X. sorbifolia's plant, based on related written documents. Chemical compound of 7-en-22dien-3 Sterols has special functions of resistance to activity of glycosuria and tumor.

A method of extracting active materials from the shell of X. sorbifolia can be impregnating extraction by using ethyl alcohol or methyl alcohol, ortho-buthyl alcohol or others alcohol, to remove solvent, retrieve solid materials, and then obtain brown granular powder after drying and grinding. This granular powder can be refined into yellow-white granular powder that can be used as raw materials for making drugs and functional foods. The yellow-white granular powder can be packed into capsules, tablets, pellets, or powder.

Utilizing the shell of X. sorbifolia will not only have economic benefits but also can cure enuresis, mental retardation and deficiency, dementia, etc. so as to achieve significant social benefits.

### METHOD OF IMPLEMENTATION

1000 g of shell of X. sorbifolia were ground down and immersed into ethyl alcohol. The ratio of ethyl alcohol and the shell of X. sorbifolia are 3:1(v/w). Extract the complex four times, each for about 4 to 6 hours, by using Soxhlet method; filter, remove solvent, then retrieve extracted liquid through distillation. After drying and grinding, 55 g extracts from the shell of X. sorbifolia is obtained. The extracts include 4.6 g crude fats, 15.0 g crude protein, 18.8 g sugar, 16.5 g Bunkankasaponin A. B. C. D. and 0.1 g sterols.

The extracts of the shell of X. sorbifolia can be used as raw materials for making drugs or functional foods. The extracts can also be directly filled into capsules, with 200 to 250 mg per capsule. One capsule can be taken each time, three times a day. While absorbing the extracts, people can get various elements of unsaturated fatty acids, amino acid as well as sterols to improve their immunities.

1. Extract Bunkankasaponin A. B. C. D., crude fats, crude proteins and sugar from the shell of Xanthoceras sorbifolia Bunge
